(19) United States
(12) Patent Application Publication
(10) Pub. No.: US 2003/0161501 A1
(43) Pub. Date: Aug. 28, 2003

(54) Image distortion for gun sighting and other applications

(75) Inventors: Michael C. Park, Portland, OR (US); Roger Thomas, Lake Oswego, OR (US)

Correspondence Address: ELMER GALBI, 13314 VERMEER DRIVE, LAKE OSWEGO, OR, 97035

(73) Assignee: iMove Inc., Portland, OR (US)

(21) Appl. No.: 10/083,273

(22) Filed: Feb. 23, 2002

(51) Int. Cl. G06K 9/00

(52) U.S. Cl. 382/103

(57) ABSTRACT

A system to provide an operator with a predictively distorted display of a theater of operations. An image of the theater is acquired with a conventional camera and then the acquired image is distorted to take into account environmental factors such as air speed, ground speed, wind speed, height, etc. For example in a simple embodiment of the present invention can be used where a platform such as an airplane is moving over a geographic feature and objects are being dropped from the platform. With the present invention, a geographic feature that is actually directly under the platform is made to appear on a display as if it is behind the platform. The reason for this is that if an object is dropped at a particular instant, it can only impact at positions that at that moment are ahead of the platform. Hence, positions ahead of the platform are made to appear directly under the platform. The amount that each pixel in the display is distorted takes into account the both the speed of the platform, the aerodynamics of any projectile, and other environmental factors.

### FIELD OF THE INVENTION

The present invention relates to cameras and image display systems, and more particularly to such systems which provide images that distort reality for particular purposes.

### BACKGROUND OF THE INVENTION

Lead gun sights that compensate for target motion are well known. In general such gun sights provide a targeting cross hair at a position removed from directly in front of the gun barrel. For example U.S. Pat. No. 5,127,165 describes an electronic system which generates a cross hair in a gun sight at a location which takes into account motion. U.S. Pat. No. 5,067,244 provides a list of prior art patents directed to various aspects of “lead gun sights”.

Weapon control systems have been developed which calculate and take into account the ballistic characteristics of projectiles when aiming various weapons in response to signals such as radar signals. For example see issued U.S. Pat. Nos. 3,845,276 and 4,146,780.

The present invention can accomplish the same general objective as the above described systems; however, the objective is accomplished in an entirely different manner. Furthermore, the present invention can be used for other purposes. The present invention utilizes imaging technology in combination with computer calculations. The technology for capturing and displaying panoramic images is well developed. For example see U.S. Pat. No. 6,337,683. Such technology can capture a plurality of images, seam the images into a panorama and display a view window into the panorama on a computer monitor.

The present invention utilizes imaging technology and the technology that can predict the trajectory of a flying object in a new combination. With the present invention an operator is presented with a panoramic wide view image that provides perspective to any targets reachable by a weapon and at the same time conveys appropriate targeting information. The purpose of the present invention is to provide a wide angle image which is predictively distorted so that an operator can easily visualize targets in an entire theater of operations and so that an operator can easily determine which targets are in the range of his weapon. The present invention also has applications beyond providing an image to aid in aiming weapons.

### SUMMARY OF THE PRESENT INVENTION

The present invention provides an operator with a predictively distorted display of a theater of operations. An image of the theater is acquired with a conventional camera and then the acquired image is distorted to take into account environmental factors such as air speed, ground speed, wind speed, height, exact distance to target, etc. For example in a simple embodiment of the present invention can be used where a platform such as an airplane is moving over a geographic feature and objects are being dropped from the platform. With the present invention, a geographic feature that is actually directly under the platform is made to appear on a display as if it is behind the platform. The reason for this is that if an object is dropped at a particular instant, it can only impact at positions that at that moment are ahead of the platform. Hence, positions ahead of the platform are made to appear directly under the platform. The amount that each pixel in the display is distorted takes into account the both the speed of the platform, the aerodynamics of any projectile, and other environmental factors. The invention can be used to provide a display that an operator would use to aim a weapon at a target. The invention can be used to predictively display an image of an environment that takes into account any known and/or predictable relationships between a moving platform and the environment.

The preferred embodiment of the invention includes a camera (or other image capturing device such as radar, sonar, etc), a computer programmed to predict the affect of relative motion between the platform and the environment and a display to show the distorted predicted view of the environment.

### BRIEF DESCRIPTION OF THE DRAWINGS

FIGS. 1A and FIG. 1B illustrate the pixels of an image.

FIGS. 2A and 2B illustrate a moving platform relative to a number of identified points.

FIG. 3 is a system block diagram.

FIG. 4 is a program flow diagram.

### DETAILED DESCRIPTION

In a first embodiment a digital panoramic image is acquired and seamed in a conventional manner. For example a panoramic image can be acquired and seamed as described in U.S. Pat. Nos. 6,337,683 and 6,323,858 and in co-pending application Ser. No. 09/602,290, filed Jun. 23, 2000 entitled “Interactive Image Seamer for Panoramic Images” the content of which is incorporated herein by reference.

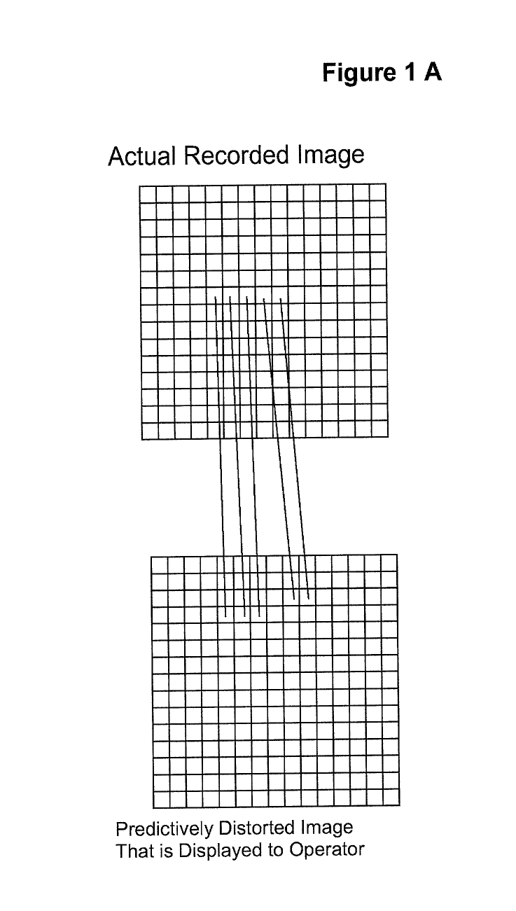

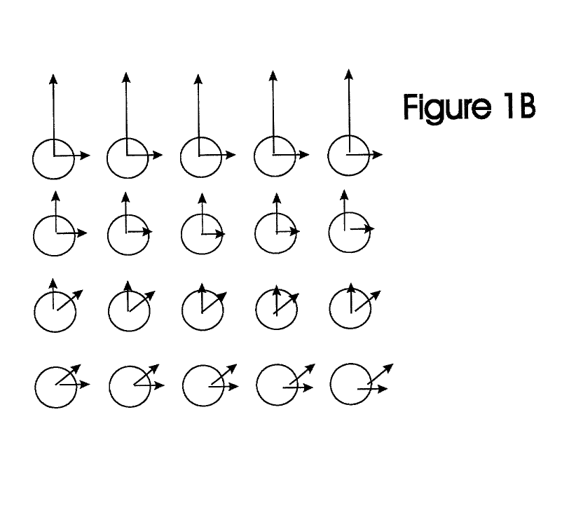

A digital image consists of an array of pixels. FIGS. 1A and 1B illustrate, in greatly exaggerated fashion, a few pixels from an image. An actual image would contain many thousands of pixels; however, for convenience of illustration, only a few of the pixels are illustrated in FIGS. 1A and 1B. Often with a panoramic image, only a selected view window into the panorama is displayed. The pixels illustrated in FIGS. 1A and 1B can be taken to represent some of the pixels in a view window or a subset of the pixels in an entire panorama.

The pixels shown will be referred to by their coordinates. For example, the pixel at the top row on the left will be referred to as pixel 11, the fist pixel in the second row will be referred to as pixel 21, and the second pixel in the second row will be referred to as pixel 22.

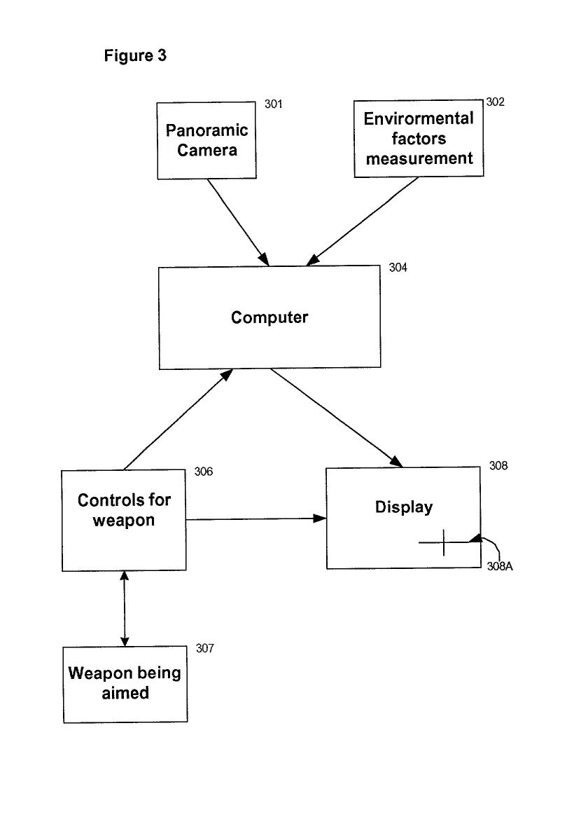

A system diagram of a preferred embodiment of the present invention is shown in FIG. 3. The system includes a panoramic camera 301 on a moving platform such as an airplane (the platform is not shown in the Figure). The camera 301 records an image. The image recorded by the camera is “predictively distorted” in a manner that will be explained later. The predictively distorted image is presented to an operator on a display 308 to help the operator take some action such as aiming a weapon 307 or dropping a bomb.

With the present invention, the value of each pixel in the perspectively distorted display either corresponds to a selected pixel (called the source pixel) in the recorded image or it is generated or modified to provide a calculated artifact (such as the fact that a certain area is out of range). It is important to note that the location of the pixel in the perspectively distorted display can be different from the location of the related source pixel in the recorded image.

FIG. 1A illustrates some of the pixels in the recorded image and some of the pixels in the perspectively distorted image that is displayed. The point of FIG. 1A is to illustrate that the value of pixels in the displayed image can originate from a source pixel in the recorded image; however, the location of a pixel in the displayed image does not generally coincide with the location of the corresponding source pixel in the recorded image.

In the following discussion a pixel will be described as having been “moved” when the location of the source pixel in the recorded image does not coincide with the location of the corresponding pixel in the displayed image. The movement of pixels will be described in terms of vectors. Examples of such vectors are illustrated by the arrows shown in FIG. 1B.

In the example shown in Figure 1A the illustrated pixels are moved as follows where the numbers given are the location index values of the pixels:

| | Pixel moved to |
|---|---|
| Pixel location in | this location in |
| source image | Distorted Image |
| 7, 6 | 4, 6 |
| 7, 7 | 4, 7 |
| 7, 8 | 3, 9 |
| 7, 9 | 3, 10 |

The above table is merely an example showing how a few pixels are moved. The above example shows that different pixels are moved by different amounts. Most pixels in the distorted image will have a corresponding source pixel. If there is no source pixel for a particular pixel in the distorted image, interpolation will be used to determine the value of the pixel from the value of adjacent pixels.

The display presented to the operator consists of the pixels in the panorama (or in the view window) each of which has been moved in accordance with the vectors applied to that particular pixel. The result is somewhat similar to what would happen if the pixels were dots on a rubber sheet and the sheet were stretched in a number of different directions. It is however noted that with a rubber sheet the spacing of the dots on the sheet changes as the sheet is stretched. However, the pixels in the recorded image and the pixels in the predictively distorted display have a particular spacing determined by the characteristics of the display. Where the dots on a sheet do not coincide to the location of the pixels in the distorted image, interpolation is used.

The distortion which is applied to images with the present invention is similar to taking an image in a drawing program and morphing the image in a particular direction. That is one can latch on to a particular point in an image an pull that point so as to distort the image. With the preset invention such distortion is done to create a display which shows a theater of operations predictively distorted to facilitate targeting a weapon such as a gun.

There can be any number of factors which affect the location of each pixel. In FIG. 1B a number of vectors are shown at the location of each pixels. Each vector represents an environmental factor that affects that pixel. The direction and magnitude of the vector indicates the direction and magnitude of the effect. For example one vector can represent how the pixel is moved due to air speed, another vector can indicate the affect due to wind velocity at that time, and another factor can represent how a pixel is moved due to the trajectory of a particular projectile. For simplicity of illustration on two vectors are show for each pixel in FIG. 1B.

The invention and its operation will first be described by using a very simple example. Next the more complicated applications of the invention in a more complicated real world environment will be described.

A simple application of the invention can be understood from the following simple example. Consider the following: if while standing in a moving vehicle one drops an item as the vehicle passes over a particular location, the item will not hit the particular location due to the motion of the vehicle. With the present invention, one would observe the environment on a display. The image on the display would be predictively distorted so that when it appears that the vehicle is moving over a particular location, the vehicle would in fact not as yet reached that location. Thus if an item is dropped as one appears (from the distorted displayed image) to be moving over a particular location, the item would in fact hit the location since the display was predictively distorted. This simple example does not take into account factors such as wind speed and the aerodynamics of the item.

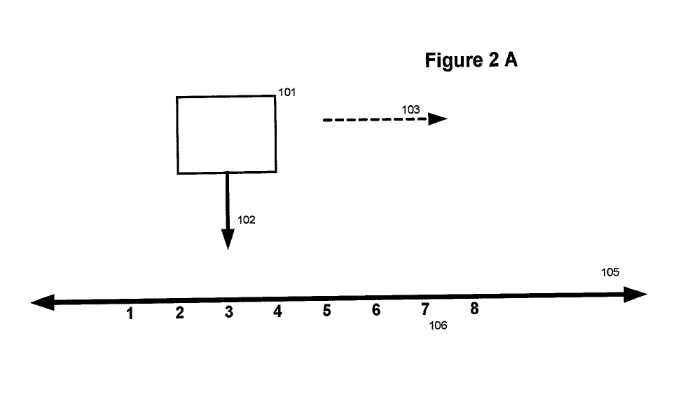

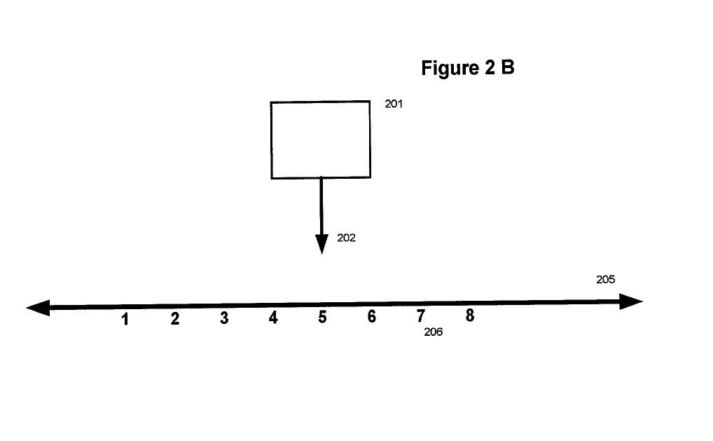

FIG. 2A illustrates a moving platform 101 which could for example be an automobile or an aircraft. The stationary environment is illustrated by line 105 which has points 1 to 8. The motion of platform 101 is in the direction of arrow 103. A view 102 which is directly down from platform 101 would focus on point 3 on the line 105. FIG. 2B illustrates what an operator would observe on a predictively distorted display when the platform 101 is at the position indicated in FIG. 2A. The operator would see a display that shows the platform over point 5 on line 105 as shown in FIG. 2B. Thus, if an operator was looking at the points on line 105 when the platform was at the position shown in FIG. 2A, the operator would see a display which shows the platform at the position shown in FIG. 2B. That is, when the platform is at the position shown in FIG. 2A, the image on the display would be predictively distorted so that it appears as if the position is a shown in FIG. 2B.

The above is a very simple example of the operation of the invention. In the above example, the pixels in the image of the terrain along a line are affected by a single vector which moves them backward by an amount determined by the speed and height of the platform (i.e. the amount is the distance the platform moves in the time it takes an item to move from the platform to the ground. Since in this example the item drops straight down, areas of the distorted display other than the area along the line would be colored or darkened to shown that only points along the line are available targets. In this example the pixels are affected by a single vector. In other embodiments the pixels could be moved in accordance with a number of vectors representing factors such as wind speed, aerodynamics of the particle, etc.

FIG. 3 is an overall systems diagram of a preferred embodiment of the invention. The system includes a panoramic camera 301. Camera 301 can for example be the type of camera shown in U.S. Pat. Nos. 6,337,683 or 6,323,858 However, other embodiments of the invention could alternately use any one of a variety of other commercially available cameras.

The system as shown in FIG. 3 includes a mechanism 302 for supplying information concerning environmental factors and data. The data provided by mechanism 302 can include projectile flight models terrain data. Mechanism 302 can include measurement apparatus that measures environmental factors such as wind speed, air speed, GPS location data, etc. In a simple embodiment, mechanism 302 could merely provide speed and height measurement. In more complex systems mechanism 302 could include devices that measures a wide variety of factors such as speed, air temperature, air pressure, GPS data, etc. The GPS data which indicates the present position of the camera can be used together with information in the terrain data base to calculate the distance from the platform to particular geographic features, thereby allowing the system to calculate if such geographic features are within target range and if so how the image need be distorted to show if the particular feature can be hit by firing the weapon at a particular time.

The output of camera 301 and environmental factor measurements 302 are fed into a computer 304. In a simple embodiment, computer 304 could be a personal computer whereas in a more complex system, computer 304 could be a remote large mainframe computer that is connected to the remaining elements in the system by a wireless link.

The purpose of the entire system shown in FIG. 3 is to control the firing of a weapon 307 that is manually aimed by a control unit 306. A cross hair 308A displayed on display 308 shows the projected impact area of a projectile fired with the controls set as they are at that moment. As the controls 306 are manipulated the cross hair 308A moves.

An operator (not shown in the drawing) manipulates controls 306 while looking at display 308. The image on display 308 is the type of image illustrated in FIG. 1. That is, the image displayed is an image of the environment; however, each pixel has been moved by an amount equal to one or more vectors. In a very simple embodiment where items are being dropped form a moving platform, the pixels would merely be moved forward to compensate for the forward speed of the platform. In such an embodiment, the image would not show the ground directly under the platform, instead it would show the ground a calculated distance in front of the platform. The area shown would coincide with the area where an object dropped from the platform would impact.

In a more complex embodiment, each pixel would be moved by the sum of a number of vectors. These additional vectors could for example take into account the speed of a cross wind and the ballistic characteristics of the weapon being fired.

If for example there were two different types of weapons are on a platform, the operator of each weapon would see a different distorted image. Pixels that coincide with areas out of range of the weapons would not even be displayed on the screen. Thus, the display would illustrate only the area that could be effectively targeted by a particular weapon.

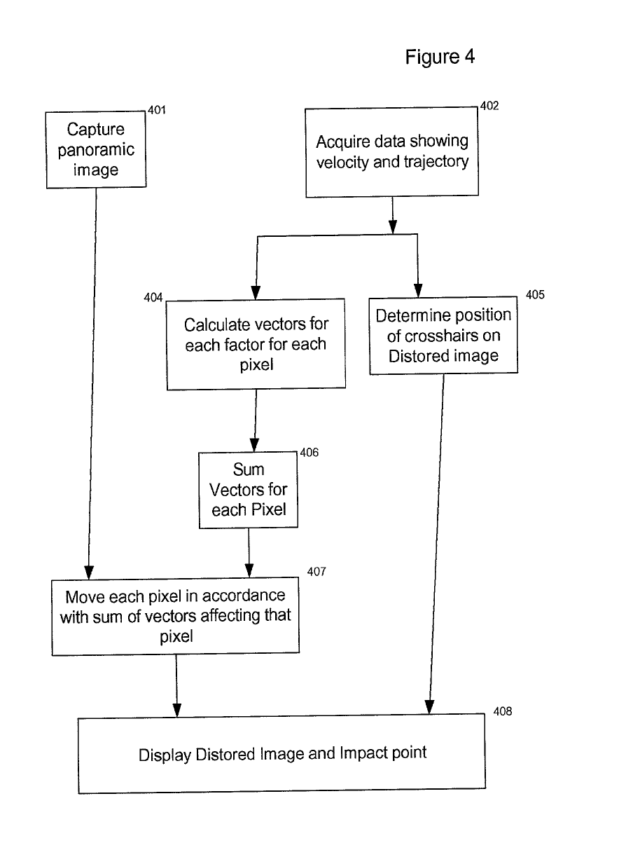

FIG. 4 is a block diagram of the computer program that produces the predictively distorted display. The system has two inputs. The first input 401 is from the camera that captures the image. The second input 402 acquires various environmental factors that affect each projectile.

As indicated by block 404, vectors are calculated for the various factors that affect projectiles filed by weapon 307. This calculation is made using a mathematical model of the flight path of the projectile which is being filed by weapon 307. For example, one vector would represent the forward motion of the platform, one vector would be for the wind velocity. Vectors are calculated for each pixel position. The vectors indicate the magnitude and direction each particular pixel must be moved to compensate for the associated factor. The various vectors that affect each pixel are summed as indicated by block 406. The sum vector for each pixel is then used to move the particular pixel as indicated by block 406. The distorted image (that is, the moved pixels) is then displayed as indicated by block 408.

The point of impact is calculated (for the setting of the weapon control 306) as indicated by block 405. This is done using conventional technology including a model of the weapon 307 and its projectile. The position of the crosshair 308A on the display 308 is calculated based upon how the weapon 307 is aimed at the particular moment.

Areas that are not in the range of weapon 307 are shown with a distinctive color or with cross hatching so that the operator can immediately see what targets are within range and available. The display thus gives the operator both a theater wide perspective view and a clear indication of what targets are available at that particular time.

The camera can also include a program that detects motion of objects. For example the fact that a vehicle is moving on the ground can be determined by comparing two images taken at different times. Such motion detection technology is known. Where a vehicle or object is moving, this fact can be illustrated on the predictively distorted display by showing a trail or smear behind that object to illustrate the motion.

While preferred embodiments of the invention have been shown and described, it will be understood by those skilled in the art that various changes in form and detail can be made without departing form the spirit and scope of the invention. The applicant's invention is limited only by the appended claims.

I claim:

1) a system for aiming a weapon which comprises
a camera for capturing an acquired image of a theater of operations,
a computer for modifying the pixels in said image to generate a predictively modified image that takes into account for environmental factors, and
a display for displaying said predictively modified image:

2) The system recited in claim 1 wherein said camera acquires a panoramic image.

3) The system recited in claim 1 wherein said computer generates a predictively modified image that designates the targets within range of said weapon.

4) The system recited claim 1 wherein said weapon is adapted to emit a projectile and wherein said computer generates a predictively modified image that takes into account the flight characteristics of said projectile.

5) The system recited in claim 1 wherein said acquired image includes a plurality of pixels and wherein a set of vectors are applied to said pixels to generate a predictively modified images, said vectors representing various factors that affect aiming said weapon.

6) The system recited in claim 1 wherein said acquired image includes a plurality of pixels and wherein said pixels are moved to generate said predictively modified image, the amount of movement of each pixel being dependent upon environmental factors and the characteristics of said weapon.

7) A system for providing guidance concerning the impact area of projectiles that leave a moving platform,
a camera for acquiring an acquired image of a target area,
a computer for modifying the pixels of said image of said target area to generate
a modified image that represents the future impact area of said projectile,
a display for displaying said modified image.

8) The system recited in claim 7 wherein said camera acquires a panoramic image.

9) The system recited in claim 7 wherein said computer generates a predictively modified image that designates the targets within range of said weapon.

10) The system recited claim 7 wherein said weapon is adapted to emit a projectile and wherein said computer generates a predictively modified image that takes into account the flight characteristics of said projectile.

11) The system recited in claim 7 wherein said acquired image includes a plurality of pixels and wherein a set of vectors are applied to said pixels to generate a predictively modified images, said vectors representing various factors that affect aiming said weapon.

12) The system recited in claim 12 wherein said acquired image includes a plurality of pixels and wherein said pixels are moved to generate said predictively modified image, the amount of movement of each pixel being dependent upon environmental factors and the characteristics of said weapon.

13) A method of generating a predictively modified image from an acquired images, said method comprising the steps of
capturing an acquired image of a theater of operations,
moving the pixels in said acquired image in accordance with a set of vectors which represent environmental factors, whereby the image represented by said moved pixels represents said predictively modified display.

14) The method in claim 13 wherein said predictively modified image is generated by stretching or compressing said acquired image in directions dictated by environmental factors.
